(19) United States
(12) Patent Application Publication
(10) Pub. No.: US 2022/0215247 A1
(43) Pub. Date: Jul. 7, 2022

(54) METHOD AND DEVICE FOR PROCESSING MULTIPLE MODES OF DATA, ELECTRONIC DEVICE USING METHOD, AND NON-TRANSITORY STORAGE MEDIUM

(71) Applicant: HON HAI PRECISION INDUSTRY CO., LTD., New Taipei (TW)

(72) Inventors: GUO-CHIN SUN, New Taipei (TW); CHIN-PIN KUO, New Taipei (TW); TUNG-TSO TSAI, New Taipei (TW)

(21) Appl. No.: 17/566,174

(22) Filed: Dec. 30, 2021

(30) Foreign Application Priority Data
Jan. 4, 2021 (CN) 202110003426.2

(51) Int. Cl. G06N 3/08; G06N 3/063; G06N 3/04; G06K 9/62

(52) U.S. Cl. CPC G06N 3/08; G06N 3/063; G06K 9/6256; G06K 9/6293; G06N 3/04

(57) ABSTRACT

A method for processing multiple modes of data with cross-learning and sharing to avoid duplicated learning generates a weighting when a neural network model is being trained with a plurality of multiple modes of training samples. The neural network model includes an input layer, a neural network backbone coupled to the input layer, and a plurality of different output layers coupled to the neural network backbone. Results of testing are output by inputting the obtained weighting into the neural network model and testing a multiple modes of test sample with the neural network model. The need for many neural network models is avoided. An electronic device and a non-transitory storage medium are also disclosed.

### FIELD

The subject matter herein generally relates to data processing, particularly to a method and a device for processing multiple modes of data, an electronic device using method, and a non-transitory storage medium.

### BACKGROUND

A number of neural network models are employed to process data in several modes, and each neural network model corresponds to one mode of data. Thus, during training of the neural network models, for employing many neural network models, a large amount of multiple modes of data must be gathered. The length of time for gathering the multiple modes of data accordingly increases. Simultaneously, the neural network models are independent of each other, and the networks cannot exchange information between them. Thus, a learning information of the neural network models during training cannot be exchanged. Repetitions in learning may be the result and a waste of resources may occur.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of a device for processing multiple modes of data in a first embodiment of the present disclosure.

FIG. 2 illustrates a block diagram of a device for processing multiple modes of data in a second embodiment of the present disclosure.

FIG. 3 illustrates a flowchart of a method for processing multiple modes of data in the first embodiment of the present disclosure.

FIG. 4 illustrates a view of a neural network model in an embodiment of the present disclosure.

FIG. 5 illustrates a flowchart of a method for processing multiple modes of data in the second embodiment of the present disclosure.

FIG. 6 illustrates a view illustrating a process for performing training by inputting multiple modes of training samples into a neural network model in a method for processing multiple modes of data in an embodiment of the present disclosure.

FIG. 7 illustrates a block diagram of an electronic device in an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

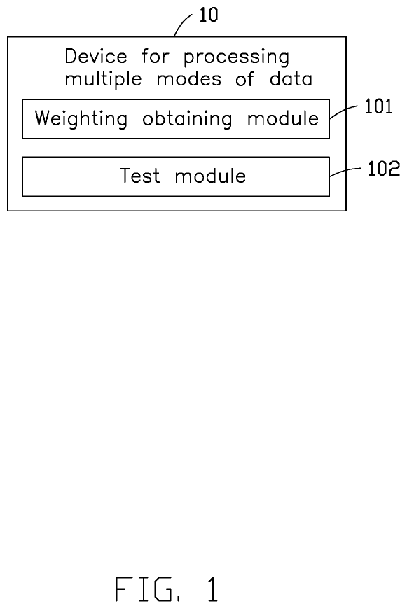

FIG. 1 illustrates a device for processing multiple modes of data 10 in a first embodiment. The device for processing multiple modes of data 10 may be applied in an electronic device. The electronic device may be a smart phone, a desktop computer, a tablet computer, or the like. The device for processing multiple modes of data 10 may include a weighting obtaining module 101 and a test module 102. The weighting obtaining module 101 obtains a weighting which is generated when a neural network model is being trained with a number of multiple modes of training samples. The neural network model includes an input layer, a neural network backbone coupled to the input layer, and a number of different output layers coupled to the neural network backbone. The test module 102 is configured to input the weighting into the neural network model to output a number of results of testing by the neural network model testing a multiple modes of test sample.

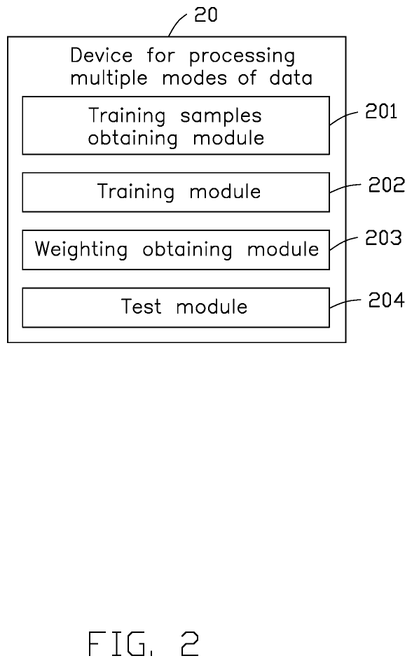

FIG. 2 illustrates a block diagram of a device for processing multiple modes of data 20 in a second embodiment. The device for processing multiple modes of data 20 can be applied in an electronic device. The electronic device can be a smart phone, a desktop computer, a tablet computer, or the like. The device for processing multiple modes of data 20 may include a training samples obtaining module 201, a training module 202, a weighting obtaining module 203, and a test module 204. The training samples obtaining module 201 is configured to obtain a number of multiple modes of training samples. The training module 202 is configured to perform training by inputting the multiple modes of training samples into a neural network model to generate a weighting of the neural network model. The weighting obtaining module 203 obtains the weighting which is generated when the neural network model is being trained with a number of multiple modes of training samples. The neural network model includes an input layer, a neural network backbone coupled to the input layer, and a number of different output layers coupled to the neural network backbone. The test module 204 is configured to input the weighting into the neural network model to output a number of results of testing by the neural network model testing a multiple modes of test sample.

Details of the functions of the modules 101˜102 and modules 201˜204 will be described.

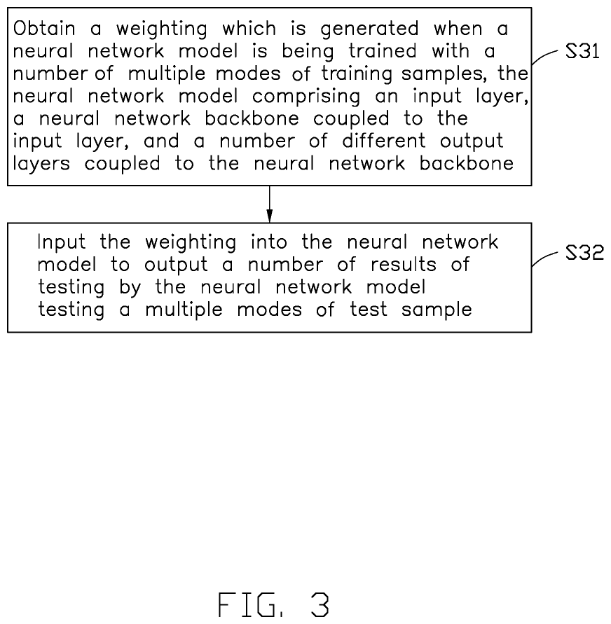

FIG. 3 is a flowchart of a method for processing multiple modes of data in the first embodiment. The method for processing multiple modes of data may include the following:

At block S31, obtaining a weighting which is generated when a neural network model is being trained with a number of multiple modes of training samples, the neural network model comprising an input layer, a neural network backbone coupled to the input layer, and a number of different output layers coupled to the neural network backbone.

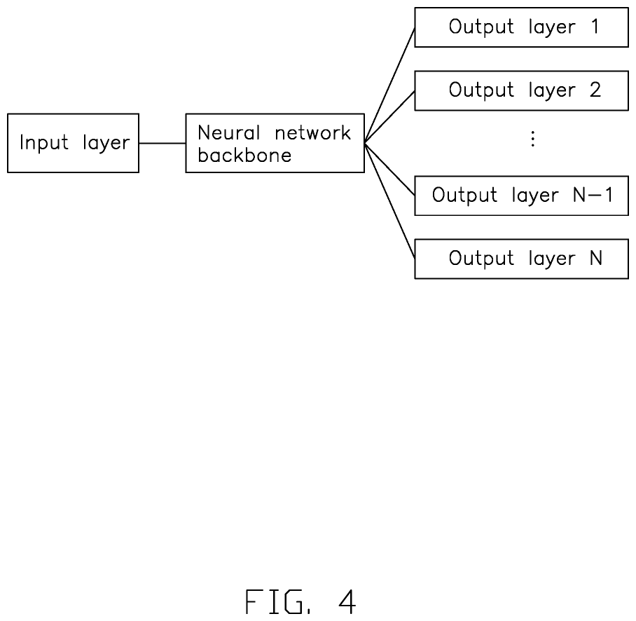

The multiple modes of training samples are samples of a pre-described thing (for example an object or a scene) gathered from different methods or different angles of view. The method further includes a step a1. The step a1 includes establishing the neural network model, as shown in FIG. 4. In FIG. 4, the neural network model includes the input layer, the neural network backbone, and the output layers. The input layer is configured to receive multiple modes of samples. The multiple modes of samples include the multiple modes of training samples and a multiple modes of test sample. The neural network backbone is configured to receive the input of the input layer and extract features of the input multiple modes of samples. In FIG. 4, the output layers include an output layer 1, an output layer 2, . . . , an output layer N−1, and an output layer N. Each of the output layers is configured to combine the features. Each of the output layers corresponds to one mode. The neural network backbone includes a residual block of a deep residual network, an inception module of an inception network, an encoder and decoder of an autoencoder, and so on. The neural network backbone includes a number of interconnected neural nodes. Thus, information in the neural network backbone is shared. Each of the output layers includes a convolutional layer, a fully connected layer, or the like.

At block S32, inputting the weighting into the neural network model to output a number of results of testing by the neural network model testing a multiple modes of test sample.

In the embodiment, before inputting the weighting into the neural network model to output a number of results of testing by the neural network model testing the multiple modes of test sample, the method further includes a step b1. The step b1 includes obtaining a multiple modes of test sample detected by a number of sensors applied to a product.

The inputting of the weighting into the neural network model to output a number of results of testing by the neural network model testing a multiple modes of test sample includes a step c1 and a step c2. The step c1 includes inputting the weighting into the neural network model to output a number of original results of testing by the neural network model testing the multiple modes of test sample. The step c2 includes post-processing the original results of testing to output the results of testing.

In the embodiment, the post-processing of the original results of testing to output the results of testing includes a step d1. The step d1 includes inputting each of the original results of testing into a post-processing function to output the results of testing in a test form or a graphic form. Each post-processing function is coupled to one output layer, and each post-processing function corresponds to one mode.

In the embodiment, the method further includes a step e1. The step el includes displaying the results of testing or controlling a behavior of the product according to the results of testing.

In the disclosure, a weighting which is generated when a neural network model is being trained with a number of multiple modes of training samples is obtained. The neural network model includes an input layer, a neural network backbone coupled to the input layer, and a number of different output layers coupled to the neural network backbone. The weighting is input into the neural network model to output results of testing by the neural network model testing a multiple modes of test sample. Thus, the multiple modes of test sample may be tested via a neural network model, the number of neural network models may be reduced, and gathering a large amount of multiple modes of data during training may be accordingly avoided. According to the disclosure, the neural network model includes the input layer, the neural network backbone coupled to the input layer, and a number of different output layers coupled to the neural network backbone. Thus, the neural network backbone is shared in the modalities, the learning processes or steps in the neural network model are accordingly shared and a waste of the resource may be accordingly avoided.

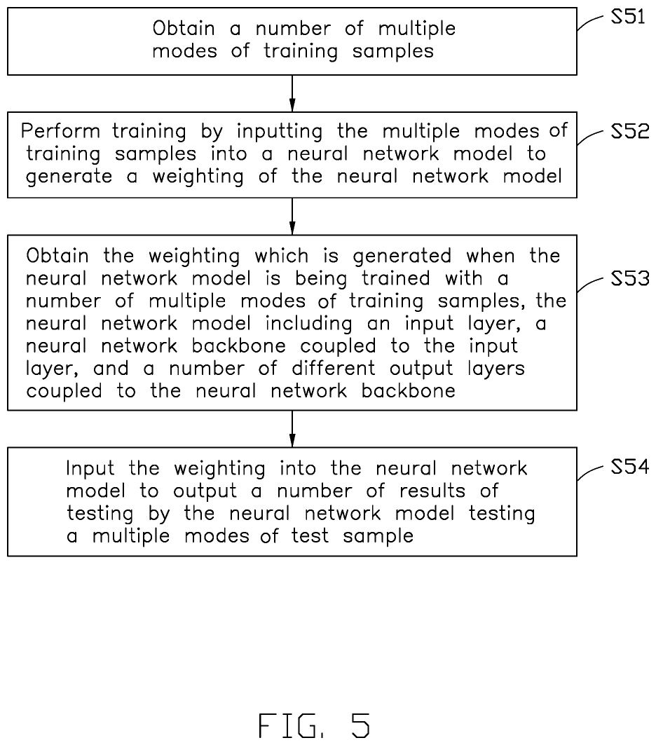

FIG. 5 is a flowchart of a method for processing multiple modes of data in the second embodiment. This method for processing multiple modes of data may include the following:

At block S51, obtaining a number of multiple modes of training samples.

The obtaining of a number of multiple modes of training samples includes a step f1 and a step f2. The step f1 includes obtaining a number of multiple modes of data detected by a number of sensors applied to a product in a preset period. The preset period may be a fixed period or a variable period. The step f2 includes establishing a database including a number of multiple modes of training samples according to the obtained multiple modes of data.

At block S52, performing training by inputting the multiple modes of training samples into a neural network model to generate a weighting of the neural network model.

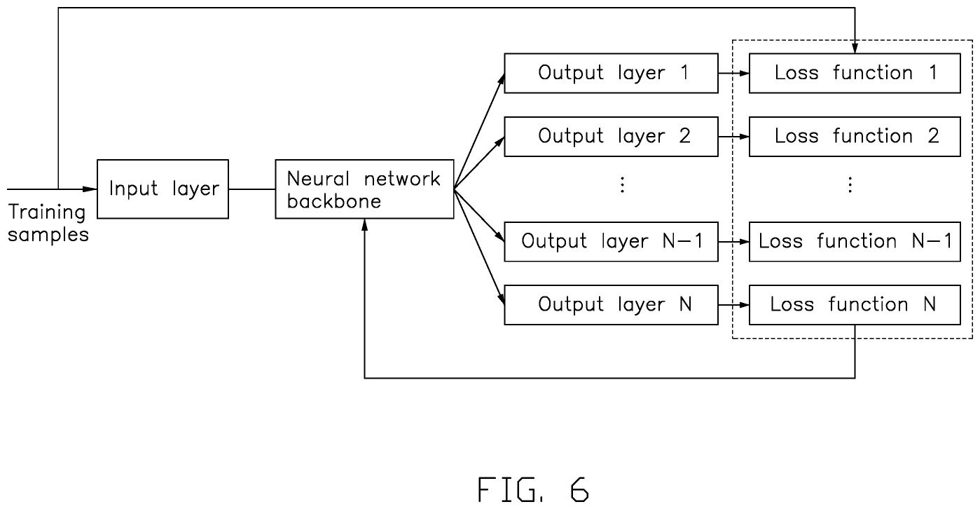

In the embodiment, the method further includes a step g1. The step g1 includes establishing a group of loss functions, as shown in FIG. 6. In FIG. 6, the loss functions in a group includes a number of loss functions. Each of the loss functions is coupled to one output layer. Each of the loss functions corresponds to one mode. The group of loss functions is coupled to an input layer and a neural network backbone. In FIG. 6, the loss functions include a loss function 1, a loss function 2, . . . , a loss function N−1, and a loss function N. In the embodiment, a dimension of result output from the output layer is the same as a dimension of the loss function.

The performing of training by inputting the multiple modes of training samples into a neural network model to generate a weighting of the neural network model includes a step h1 and a step h2. The step h1 includes performing training by inputting the multiple modes of training samples into the neural network model to generate a result of training via each of the output layers. The step h2 includes employing the loss functions to adjust a training weighting of the neural network model by inputting each result of training into a corresponding loss function until the training of the neural network model is completed, to generate the weighting of the neural network model.

At block S53, obtaining the weighting which is generated when the neural network model is being trained with a number of multiple modes of training samples, the neural network model including an input layer, a neural network backbone coupled to the input layer, and a number of different output layers coupled to the neural network backbone.

The block S53 of the second embodiment is the same as the block S31 of the first embodiment, details thereof are as the description of the block S31 of the first embodiment, and are not repeated.

At block S54, inputting the weighting into the neural network model to output a number of results of testing by the neural network model testing a multiple modes of test sample.

The block S54 of the second embodiment is the same as the block S32 of the first embodiment, details thereof are as the description of the block S32 of the first embodiment, and are not repeated.

In the disclosure, a number of multiple modes of training samples are obtained, and a weighting of a neural network model is generated by inputting the multiple modes of training samples into the neural network model to perform training. The weighting which is generated when the neural network model is being trained with a number of multiple modes of training samples is obtained. The neural network model includes an input layer, a neural network backbone coupled to the input layer, and a number of different output layers coupled to the neural network backbone. The weighting is further input into the neural network model to output results of testing by the neural network model testing a multiple modes of test sample. Thus, the weighting may be generated by training the neural network model. Further in the disclosure, the neural network model includes a number of different output layers coupled to the neural network backbone, thus each of the output layers may learn a corresponding specific function, and one input layer, one neural network backbone, and many output layers may correspond to the conventional neural networks. The multiple modes of test sample may also be tested via a neural network model, the need for many neural network models may be accordingly avoided, and a gathering of large amounts of multiple modes of data during training may be accordingly avoided. Also, according to the disclosure, the neural network model includes an input layer, a neural network backbone coupled to the input layer, and a number of different output layers coupled to the neural network backbone. Thus, the neural network backbone shares the modes, the learning steps in the neural network model, being shared, do not need to be duplicated, and a waste of the resource may be accordingly avoided.

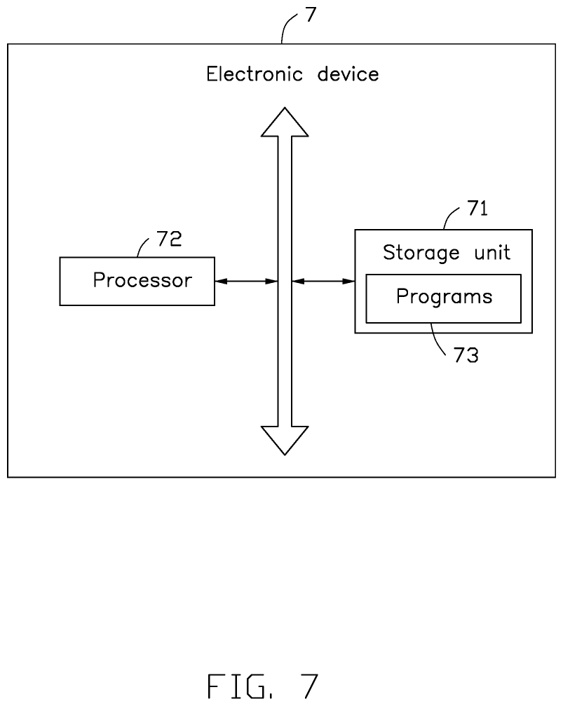

FIG. 7 illustrates a block diagram of an electronic device 7 in an embodiment. The electronic device 7 may include a storage unit 71, at least one processor 72, and one or more programs 73 stored in the storage unit 71 which may be run on the at least one processor 72. The at least one processor 72 may execute the one or more programs 73 to accomplish the blocks of the exemplary method. Or the at least one processor 72 may execute the one or more programs 73 to accomplish the functions of the modules of the exemplary device.

The one or more programs 73 may be divided into one or more modules/units. The one or more modules/units may be stored in the storage unit 71 and executed by the at least one processor 72 to accomplish the purpose of the method. The one or more modules/units may be a series of program command segments which may perform specific functions, and the command segment is configured to describe the execution process of the one or more programs 73 in the electronic device 7. For example, the one or more programs 73 may be divided into modules as shown in FIG. 1 and FIG. 2, the functions of each module are as described in the first embodiment and the second embodiment.

The electronic device 7 may be any suitable electronic device, for example, a personal computer, a tablet computer, a mobile phone, a PDA, or the like. A person skilled in the art knows that the device in FIG. 7 is only an example and is not to be considered as limiting of the electronic device 7, another example may include more or fewer parts than the diagram, or may combine certain parts, or include different parts, such as more buses and so on.

The at least one processor 72 may be one or more central processing units, or it may be one or more other universal processors, digital signal processors, application specific integrated circuits, field-programmable gate arrays, or other programmable logic devices, discrete gate or transistor logic, discrete hardware components, and so on. The at least one processor 72 may be a microprocessor or the at least one processor 72 may be any regular processor or the like. The at least one processor 72 may be a control center of the electronic device 7, using a variety of interfaces and lines to connect various parts of the entire electronic device 7.

The storage unit 71 stores the one or more programs 73 and/or modules/units. The at least one processor 72 may run or execute the one or more programs 73 and/or modules/units stored in the storage unit 71, call out the data stored in the storage unit 71 and accomplish the various functions of the electronic device 7. The storage unit 71 may include a program area and a data area. The program area may store an operating system, and applications that are required for the at least one function, such as sound or image playback features, and so on. The data area may store data recorded during the use of the electronic device 7, such as audio data, and so on. In addition, the storage unit 71 may include a non-transitory storage medium, such as hard disk, memory, plug-in hard disk, smart media card, secure digital, flash card, at least one disk storage device, flash memory, or another non-transitory storage medium.

If the integrated module/unit of the electronic device 7 is implemented in the form of or by means of a software functional unit and is sold or used as an independent product, all parts of the integrated module/unit of the electronic device 7 may be stored in a computer-readable storage medium. The electronic device 7 may use one or more programs to control the related hardware to accomplish all parts of the method of this disclosure. The one or more programs may be stored in a computer-readable storage medium. The one or more programs may apply the exemplary method when executed by the at least one processor. The one or more stored programs may include program code. The program code may be in the form of source code, object code, executable code file, or in some intermediate form. The computer-readable storage medium may include any entity or device capable of recording and carrying the program codes, recording media, USB flash disk, mobile hard disk, disk, computer-readable storage medium, and read-only memory.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for processing multiple modes of data comprising:
obtaining a weighting which is generated when a neural network model is being trained with a plurality of multiple modes of training samples, the neural network model comprising an input layer, a neural network backbone coupled to the input layer, and a plurality of different output layers coupled to the neural network backbone;
inputting the weighting into the neural network model to output a plurality of results of testing by the neural network model testing a multiple modes of test sample.

2. The method according to claim 1, wherein the inputting the weighting into the neural network model to output a plurality of results of testing by the neural network model testing a multiple modes of test sample comprises:
inputting the weighting into the neural network model to output a plurality of original results of testing by the neural network model testing the multiple modes of test sample;
post-processing the plurality of original results of testing to output the plurality of results of testing.

3. The method according to claim 1, further comprising:
establishing the neural network model, the input layer being configured to receive multiple modes of samples, the multiple modes of samples comprising the plurality of multiple modes of training samples and the multiple modes of test sample; the neural network backbone being configured to receive the input of the input layer and extract features of the input multiple modes of samples; each of the plurality of different output layers being configured to combine the features, and each of the plurality of different output layers corresponding to one mode.

4. The method according to claim 3, wherein the neural network backbone comprises a residual block of a deep residual network, an inception module of an inception network, and an encoder and decoder of an autoencoder.

5. The method according to claim 3, wherein each of the plurality of different output layers comprises a convolutional layer or a fully connected layer.

6. The method according to claim 3, wherein before the obtaining the weighting which is generated when the neural network model is being trained with the plurality of multiple modes of training samples, the method further comprises:
obtaining the plurality of multiple modes of training samples;
performing training by inputting the plurality of multiple modes of training samples into the neural network model to generate the weighting of the neural network model.

7. The method according to claim 6, wherein:
the method further comprises:
establishing a group of loss functions, where the group of loss functions comprising a plurality of different loss functions, each of the loss functions being coupled to one output layer; each of the loss functions corresponding to one mode; the group of loss functions being coupled to the input layer and the neural network backbone;
the performing training by inputting the plurality of multiple modes of training samples into the neural network model to generate the weighting of the neural network model comprises:
performing training by inputting the plurality of multiple modes of training samples into the neural network model to generate a result of training via each of the plurality of different output layers;
employing the group of loss functions to adjust a training weighting of the neural network model by inputting each of the plurality of results of training into a corresponding loss function until the training of the neural network model is completed, to generate the weighting of the neural network model.

8. An electronic device comprising:
a storage device;
at least one processor; and
the storage device storing one or more programs, which when executed by the at least one processor, cause the at least one processor to:
obtain a weighting which is generated when a neural network model is being trained with a plurality of multiple modes of training samples, the neural network model comprising an input layer, a neural network backbone coupled to the input layer, and a plurality of different output layers coupled to the neural network backbone;
input the weighting into the neural network model to output a plurality of results of testing by the neural network model testing a multiple modes of test sample.

9. The electronic device according to claim 8, further causing the at least one processor to:
input the weighting into the neural network model to output a plurality of original results of testing by the neural network model testing the multiple modes of test sample;
post-process the plurality of original results of testing to output the plurality of results of testing.

10. The electronic device according to claim 8, further causing the at least one processor to:
establish the neural network model, the input layer being configured to receive multiple modes of samples, the multiple modes of samples comprising the plurality of multiple modes of training samples and the multiple modes of test sample; the neural network backbone being configured to receive the input of the input layer and extract features of the input multiple modes of samples; each of the plurality of different output layers being configured to combine the features, and each of the plurality of different output layers corresponding to one mode.

11. The electronic device according to claim 10, wherein the neural network backbone comprises a residual block of a deep residual network, an inception module of an inception network, and an encoder and decoder of an autoencoder.

12. The electronic device according to claim 10, wherein each of the plurality of different output layers comprises a convolutional layer or a fully connected layer.

13. The electronic device according to claim 10, further causing the at least one processor to:
obtain the plurality of multiple modes of training samples;
perform training by inputting the plurality of multiple modes of training samples into the neural network model to generate the weighting of the neural network model.

14. The electronic device according to claim 13, further causing the at least one processor to:
establish a group of loss functions, where the group of loss functions comprising a plurality of different loss functions, each of the loss functions being coupled to one output layer; each of the loss functions corresponding to one mode; the group of loss functions being coupled to the input layer and the neural network backbone;
perform training by inputting the plurality of multiple modes of training samples into the neural network model to generate a result of training via each of the plurality of different output layers;
employ the group of loss functions to adjust a training weighting of the neural network model by inputting each of the plurality of results of training into a corresponding loss function until the training of the neural network model is completed, to generate the weighting of the neural network model.

15. A non-transitory storage medium storing a set of commands, when the commands being executed by at least one processor of an electronic device, causing the at least one processor to:
obtain a weighting which is generated when a neural network model is being trained with a plurality of multiple modes of training samples, the neural network model comprising an input layer, a neural network backbone coupled to the input layer, and a plurality of different output layers coupled to the neural network backbone;
input the weighting into the neural network model to output a plurality of results of testing by the neural network model testing a multiple modes of test sample.

16. The non-transitory storage medium according to claim 15, further causing the at least one processor to:
input the weighting into the neural network model to output a plurality of original results of testing by the neural network model testing the multiple modes of test sample;
post-process the plurality of original results of testing to output the plurality of results of testing.

17. The non-transitory storage medium according to claim 15, further causing the at least one processor to:
establish the neural network model, the input layer being configured to receive multiple modes of samples, the multiple modes of samples comprising the plurality of multiple modes of training samples and the multiple modes of test sample; the neural network backbone being configured to receive the input of the input layer and extract features of the input multiple modes of samples; each of the plurality of different output layers being configured to combine the features, and each of the plurality of different output layers corresponding to one mode.

18. The non-transitory storage medium according to claim 17, wherein the neural network backbone comprises a residual block of a deep residual network, an inception module of an inception network, and an encoder and decoder of an autoencoder.

19. The non-transitory storage medium according to claim 17, further causing the at least one processor to:
obtain the plurality of multiple modes of training samples;
perform training by inputting the plurality of multiple modes of training samples into the neural network model to generate the weighting of the neural network model.

20. The non-transitory storage medium according to claim 19, further causing the at least one processor to:
establish a group of loss functions, where the group of loss functions comprising a plurality of different loss functions, each of the loss functions being coupled to one output layer; each of the loss functions corresponding to one mode; the group of loss functions being coupled to the input layer and the neural network backbone;
perform training by inputting the plurality of multiple modes of training samples into the neural network model to generate a result of training via each of the plurality of different output layers;
employ the group of loss functions to adjust a training weighting of the neural network model by inputting each of the plurality of results of training into a corresponding loss function until the training of the neural network model is completed, to generate the weighting of the neural network model.
